(19) United States
(12) Patent Application Publication
(10) Pub. No.: US 2018/0141161 A1
(43) Pub. Date: May 24, 2018

(54) SYNTHESIS OF ASTEROIDAL OR METEORITICAL POWDER FOR ADDITIVE MANUFACTURE OF HIGH FIDELITY METALLIC COMPONENTS IN SPACE

(71) Applicant: LAWRENCE LIVERMORE NATIONAL SECURITY, LLC, Livermore, CA (US)

(72) Inventor: John W. Elmer, Danville, CA (US)

(21) Appl. No.: 15/358,611

(22) Filed: Nov. 22, 2016

(51) Int. Cl. B23K 26/342; B33Y 10/00; B33Y 30/00; B33Y 40/00; B33Y 50/02; B23K 15/00

(52) U.S. Cl. CPC B23K 26/342; B33Y 10/00; B33Y 30/00; B23K 2203/02; B33Y 50/02; B23K 15/0006; B33Y 40/00

(57) ABSTRACT

Apparatus, systems, and methods for synthesis of powder from asteroids or meteorites and the use of the powder as the feed source for additive manufacturing systems deployed in space. Location and analysis of suitable asteroids or meteorites is demonstrated on earth and later used to produce components and products in space using natural space resources. The method includes the steps of locating an asteroid, making contact with the asteroid using meteorites on earth, harvesting material from the asteroid, processing material from the asteroid producing additive manufacturing quality powder, using the additive manufacturing quality powder as a feed stock for additive manufacturing in space, and completing the parts or products by the additive manufacturing in space.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

### Field of Endeavor

The present application relates to additive manufacturing and more particularly to additive manufacturing of components from asteroidal or meteoritical powder for extraterrestrial endeavors.

### State of Technology

This section provides background information related to the present disclosure which is not necessarily prior art.

Commercial space activities are now beginning in earnest with private ventures opening up new possibilities for space exploration. Both scientific as well as economic goals are being pursued, leading the way for potential space manufacturing and future colonization. Colonies and/or space manufacturing facilities will only be feasible if they rely minimally on material exports from Earth due to the high cost penalty of transportation through Earth's gravitational field. Because of this, bulk materials for space construction are likely to come from the Moon, near-Earth objects, or asteroids, which are known to be rich in mineral and metal content. Metals have favorable structural properties, and iron, which is the most abundant metallic element in our galaxy, makes it a likely candidate for space construction. Iron is known to exist in its metallic form in iron meteorites, and if it can be made into suitable powder, additive manufacturing (AM) methods would be able to use it for the direct digital manufacture of metallic components in space.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

High quality powder of the correct composition and size distribution is required for additive manufacturing (AM) processes involving laser and electron beam based AM systems in order to produce near fully dense AM components with minimal defects. The disclosed apparatus, systems, and methods provide synthesis of powder from asteroids or meteorites and the use of the powder as the feed source for AM systems deployed in space. Location and analysis of suitable asteroids or meteorites can be demonstrated on earth and later used to produce components and products in space using natural space resources. The disclosed apparatus, systems, and methods provide an additive manufacturing method for producing parts or products in space including the steps of locating an asteroid, making contact with the asteroid or meteorite, harvesting material from the asteroid, processing the material from the asteroid producing additive manufacturing quality powder, using the additive manufacturing quality powder as a feed stock for additive manufacturing in space, and completing the parts or products by the additive manufacturing in space.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates one embodiment of the inventor's apparatus, systems, and methods.

FIGS. 2-8 illustrate another embodiment of the inventor's apparatus, systems, and methods.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Colonies and/or space manufacturing facilities will only be feasible if they rely minimally on material exports from Earth due to the high cost penalty of transportation through Earth's gravitational field. Because of this, bulk materials for space construction are likely to come from the Moon, near-Earth objects, or asteroids, which are known to be rich in mineral and metal content. Metals have favorable structural properties, and iron, which is the most abundant metallic element in our galaxy, makes it a likely candidate for space construction. Iron is known to exist in its metallic form in iron meteorites, and if it can be made into suitable powder, additive manufacturing (AM) methods would be able to use it for the direct digital manufacture of metallic components in space.

### Definition

The word “meteorite” as used in this application has the following definition: “a solid piece of an asteroid or comet that is found on planets (e.g. Earth or Mars) or on planetary satellites (eg. Moon).”

The inventors' apparatus, systems, and methods provide synthesis of powder from asteroids and the use of the powder as the feed source for AM systems deployed in space. AM components made from the powder can be demonstrated on earth and later used to produce components and products in space using natural space resources. The inventors' apparatus, systems, and methods provide an additive manufacturing apparatus for producing parts or products including a system for synthesizing metal alloy powder from iron-nickel asteroids providing synthesized metal alloy powder and an additive manufacturing system for using the synthesized metal alloy powder for completing the parts or products by the additive manufacturing in space. The inventors' apparatus, systems, and methods also provide an additive manufacturing method for producing parts or products, including the steps of synthesizing metal alloy powder from iron-nickel asteroids providing synthesized metal alloy powder, using the synthesized metal alloy powder as a feed stock for additive manufacturing, and completing the parts or products by the additive manufacturing on earth or in space.

The inventors' apparatus, systems, and method provide developing of AM powders synthesized from asteroidal or meteoritical sources. Synthesis of AM powder from asteroids will be performed by metallurgical thermochemical operations including metal refining to reduce the nonmetallic impurities in iron-rich asteroids. Refining will utilize silicate and oxide minerals such as those known to be present in the lunar regolith. Powder processing in space will be facilitated by the vacuum conditions of space and the low gravity conditions that favor the formation of desired spherical powders.

Since meteoritic iron is not suitable for AM processing in its native state due to nonmetallic elements that result in weld cracking, modifications to the meteorite chemistry are required to be able to produce crack-free AM components using powders made from asteroids or meterorites. Many AM techniques have been developed requiring powders. These processes fall into two main categories: powder bed or powder fed processes, and use either lasers or electron beams as the heat source. Processes such as Laser Additive Manufacturing (LAM) powder bed and powder fed, Selected Laser Melting (SLM) powder bed, Laser Metal Deposition (LMD) powder bed and powder fed, Electron Beam Additive Manufacturing (EBAM) powder bed, directed energy deposition (DED) powder fed, laser engineered net shaping (LENS) powder fed, and generic powder fed processes such as laser powder cladding and surfacing. All of these techniques rely on a source of powder that can be melted and resolidified with full density and high mechanical integrity. These small melt pools can be thought of as small welds that are placed on top of each other in layers to produce the desired structural shape. Therefore, in order for a powder to be suitable for AM processing using the methods listed above, it must be able to be welded without cracking and without producing high levels of porosity. Until recently, it was unknown if metallic materials from extraterrestrial sources could be welded in their native state. Results of this study showed that there are significant challenges to be faced when welding meteoritic iron due to its high content of non-metallic elements such as phosphorous, sulfur, and carbon. The high phosphorous and sulfur contents were shown to lead to solidification cracking, which is detrimental to the strength of the weld. Localized high carbon containing phases contribute to variable and increased weld hardness, which is an additional fusion zone cracking concern. Thus if powders were produced directly form meteoritic material, this material would not be expected to be suitable for AM methods due to cracking concerns and variable mechanical properties in the melted and resolidified structure of the AM components. Additional details are included in an article by the inventor and others published in 2014, “J. W. Elmer, C. L. Evans, J. J. Embree, G. F. Gallegos, and L. T. Summers, “Electron Beam Weldability of a Group IAB Iron Meteorite,” Science and Technology of Welding and Joining, V19(4), pp. 295-301, 2014.

### EXAMPLES

The inventor's apparatus, systems, and methods will now be described purely by way of non-limitative examples, with reference to the attached drawings, which illustrate embodiments of the inventor's apparatus, systems, and methods.

### Example 1

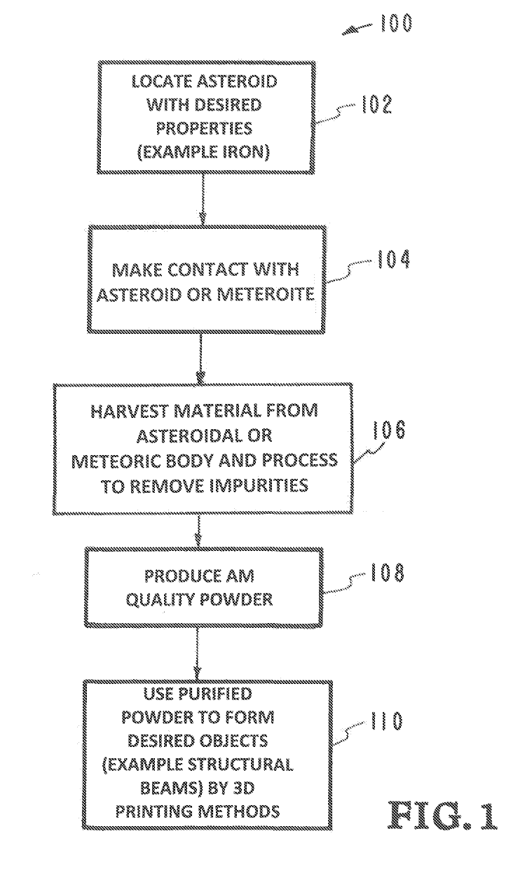

Referring now to the drawings and in particular to FIG. 1, an embodiment of the inventor's apparatus, systems, and methods is shown. The embodiment is designated generally by the reference numeral 100. The embodiment 100 provides apparatus, systems, and methods for producing parts or products in space by additive manufacturing.

The inventor's apparatus, systems, and methods for producing parts or products in space by additive manufacturing 100 are illustrated by a flow chart. As shown in the flow chart, step 102 comprises locating an asteroid with desired properties. The desired properties can be iron or iron alloys such as iron-nickel, iron-nickel-cobalt, including low thermal expansion alloys, and steel alloys that also contain carbon. Metals have favorable structural properties, and iron, which is the most abundant metallic element in our galaxy, makes it a likely candidate for space construction. Iron is known to exist in its metallic form in iron meteorites, and if it can be made into suitable powder, additive manufacturing (AM) methods would be able to use it for the direct digital manufacture of steel and other iron-containing metallic alloy components in space.

As shown in the flow chart, step 104 comprises making contact with said asteroid using meteorites on earth. Analysis and processing of meteorites on earth coupled with spectrographic analysis of asteroids in space can help in locating an asteroid with desired properties.

As shown in the flow chart, step 106 comprises harvesting material from the asteroid. This will require special equipment to handle the extraction and processing of material. The material can be moved about more readily due to the lack of gravity.

As shown in the flow chart, step 108 comprises processing said material from said asteroid producing additive manufacturing quality powder. In order for a powder to be suitable for additive manufacturing processing, it must be able to be welded without cracking and without producing high levels of porosity. Meteoritic iron is expected to have high content of non-metallic elements such as phosphorous, sulfur, and carbon. The high phosphorous and sulfur contents can lead to solidification cracking, which is detrimental to the strength of parts or products.

As shown in the flow chart, step 110 comprises using said additive manufacturing quality powder for completing parts or products by said additive manufacturing in space. Experiments by NASA have demonstrated that a 3D printer works normally in space. In general, a 3D printer extrudes streams of heated plastic, or deposit molten metals or other materials, building layer on top of layer to create 3 dimensional objects. NASA has tested a 3D printer on the International Space Station.

### Example 2

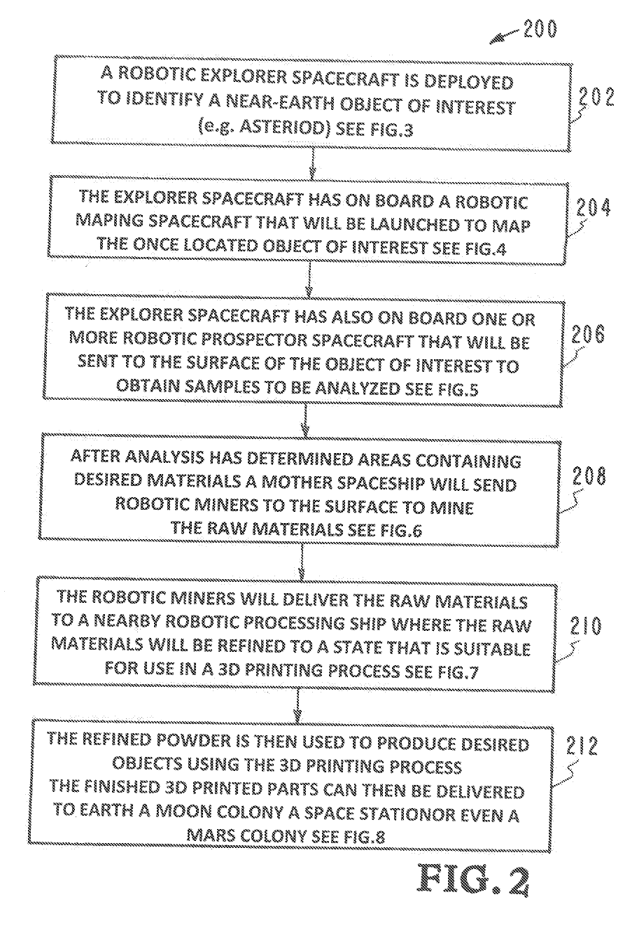

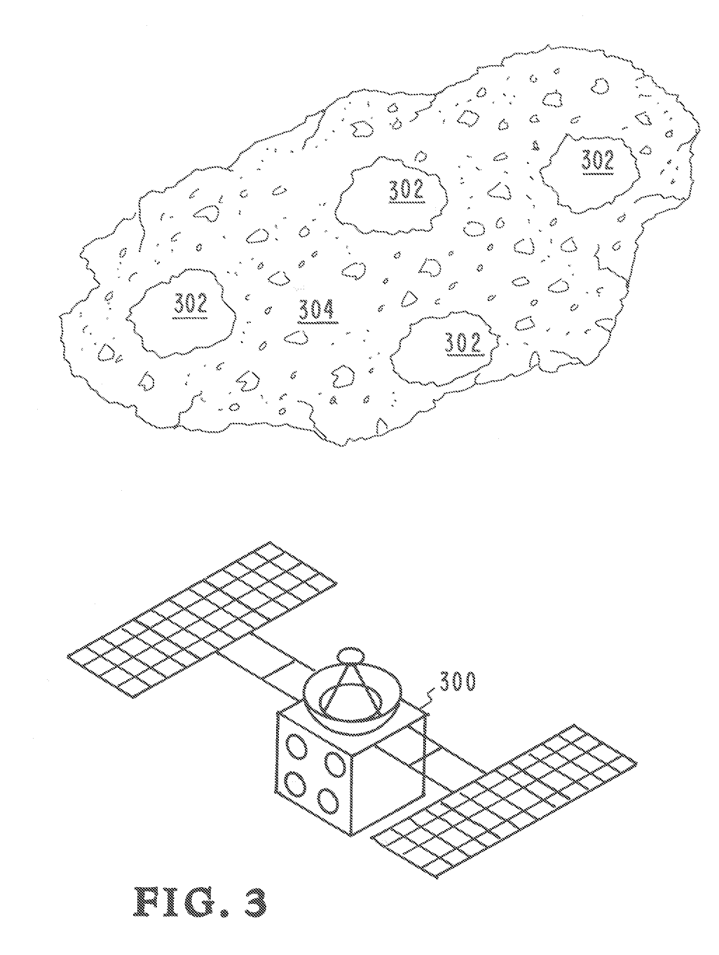

Referring now to FIG. 2, another embodiment of the inventor's apparatus, systems, and methods is illustrated. This embodiment provides apparatus, systems, and methods for producing parts or products in space by additive manufacturing and is illustrated by a flow chart. The flow chart is designated generally by the reference numeral 200. The flow chart 200 is a diagram that provides a workflow or process using boxes representing portions of the workflow or process with their order illustrated by connecting the boxes with arrows. This diagrammatic representation illustrates the inventor's apparatus, systems, and methods for providing apparatus, systems, and methods for producing parts or products in space by additive manufacturing. The workflow or process flow chart 200 includes the following workflow elements and process steps:
flow chart box 202—robotic explorer spacecraft deployed.
flow chart box 204—robotic mapping spacecraft launched to map object of interest,
flowchart box 206—robotic prospector spacecraft sent to the surface to obtain samples,
flow chart box 208—robotic miners sent to the surface to mine the raw materials,
flow chart box 210—robotic miners deliver the raw materials to robotic processing ship where raw materials refined to a high quality metal powder suitable for use in 3D printing, and
flow chart box 212—finished powder used for 3D printing of parts or products that will be delivered to earth, a moon colony, a space station, or even a mars colony. The workflow elements and process steps 202, 204, 206, 206, 210 and 212 are illustrated and described in greater detail in FIGS. 3-8.

Referring now to FIG. 3, additional details of the workflow elements and process steps of box 202 are illustrated. A robotic explorer spacecraft 300 is deployed to identify potential sites 302 of raw material on a near-earth asteroid 304. Additional information about the exploration of potential sites for suitable raw material is provided in U.S. Pat. No. 9,266,627; the disclosure of which is incorporated herein by this reference.

U.S. Pat. No. 9,266,627 describes exploring asteroids to determine their position, composition, and/or the accessibility of their resources as follows: “According to embodiments, Earth-remote sensing can comprise inspection using ground telescope. Additionally or alternatively, one or more exploratory robotic spacecraft (e.g., including a space telescope) can launch from earth and travel to the asteroid(s) of interest. For example, the spacecraft can explore, locate, identify, and/or characterize the asteroids of interest, for example, as shown in FIG. 2. Parameters considered while prospecting asteroids can include, for example, which asteroids are easiest to reach energetically, the material needed on them, and the asteroid's periodicity. Additionally or alternatively, the criteria can include: spin rate and pole orientation; bulk type classification; size; existence of binary/ternary; mass and density; shape model; surface morphology and properties; dust environment (natural and induced); gravitational field structure; homogeneity (composition); internal structure (e.g., monolithic vs. rubble pile vs. depth); and/or subsurface properties. Additionally or alternatively, the criteria can include general mineral and chemical composition, such as: presence of resource materials to 10% (e.g., H₂O, volatiles); presence of metals, such as Fe, Ni, and Co; and/or trace presence of platinum group metals. These properties can be determined using combinations of known technologies. For example, mineral composition can be determined using spectroscopy, for example reflection spectroscopy. Using such techniques, asteroids can be classified into the existing asteroid spectral classification system, into other existing classifications, and into new classifications relevant to prospecting for particular substances. According to an embodiment, detailed information about potential ore bodies can be acquired starting with coarse measurements meant to locate higher quality ore from barren lands, for example, in step 110. In step 110, coarse measurements can include flyby missions of the asteroids, for example, using a spacecraft having a space telescope. In step 120, more sensitive, capable and focused equipment can be utilized as the pool of candidate asteroids is reduced through the prospecting process. This can occur, for example, by rendezvous and orbital missions to the asteroids. Ultimately, enough information on asteroid targets can be acquired to identify viable asteroids for mining, e.g., in step 130. According to an embodiment, the identification can be based at least in part on the concentration of desired materials, the homogeneity of materials, and the economic feasibility of extraction of materials to market.”

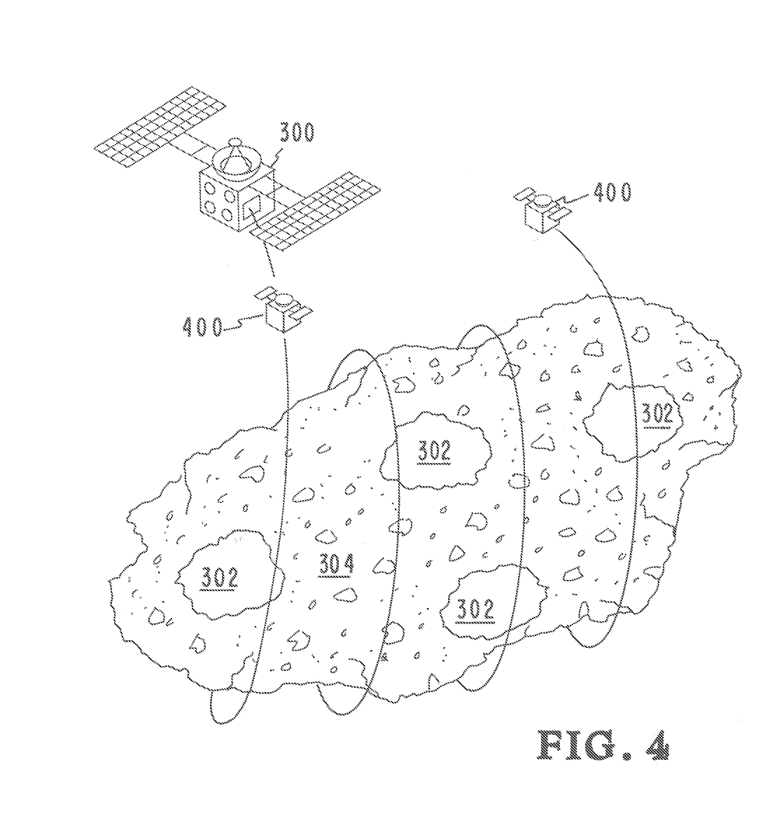

Referring now to FIG. 4, additional details of the workflow elements and process steps of box 204 are illustrated. As illustrated by flow chart box 204 the explorer spacecraft 300 has on board a robotic mapping spacecraft 400 that will be launched to map the once located objects of interest 302 on the asteroid 304. Additional information about a robotic mapping is provided in U.S. Pat. No. 9,266,627; the disclosure of which is incorporated herein by this reference.

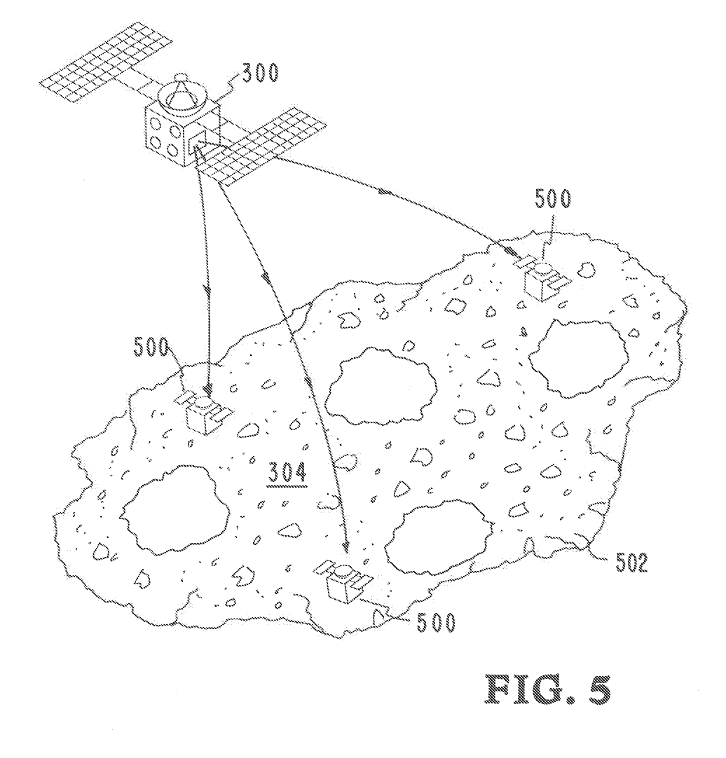

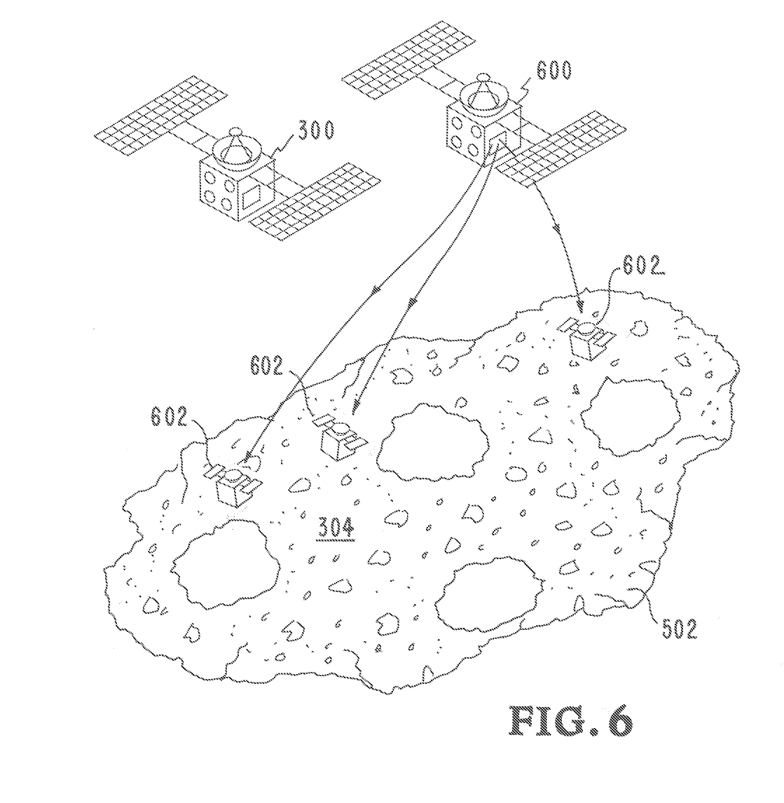

U.S. Pat. No. 9,266,627 describes robotic mapping as follows: “Referring to FIGS. 3 and 4, an embodiment of a space craft including a space telescope is shown. The space telescope shown in FIGS. 3 and 4 can be utilized, for example, in low Earth orbit, to explore, examine, and analyze asteroids to identify target asteroids for further consideration. According to embodiments, the space craft shown in FIGS. 3 and 4 can include structures, avionics, attitude determination and control, and instrumentation necessary for low-cost asteroid exploration. According to an embodiment, the space telescope of FIGS. 3 and 4 can include a precision imaging system. With arc-second resolution, the camera can provide detailed celestial and Earth observations where and when desired. Through spectroscopy and other remote sensing techniques, a selection of asteroid candidates suitable for resource exploration can be identified. An example of the space telescope shown in FIGS. 3 and 4 is the Large Scale Synoptic Telescope (LSST). Further details regarding the space craft and space telescope shown in FIGS. 3 and 4 can be found in applicant's co-pending U.S. Provisional Application No. 61/800,813, filed on Mar. 15, 2013, the entire content of which is incorporated herein by reference. FIG. 5 depicts another space craft including a space telescope. The space craft of FIG. 5 can be similar to that of FIGS. 3 and 4, except that it can further include propulsion capabilities and additional scientific instrumentation. Accordingly, the space craft of FIG. 5 can be suitable for an Earth-crossing asteroid interceptor mission. According to embodiments, the space craft of FIG. 5 can piggy back with a launched satellite headed for a geostationary orbit, allowing the space craft to be well positioned to fly-by and collect data on prospect asteroids. According to embodiments, two or more of the space craft shown in FIG. 5 can work together as a team to potentially identify, track, and fly-by the asteroids that travel between the Earth and our Moon. The closest encounters may result in a planned spacecraft “intercept,” providing the highest-resolution data. These missions will allow the quick acquisition of data on several near-Earth asteroids. Referring to FIG. 6, the spacecraft can be augmented with deep space laser communication capability. This can allow the spacecraft to be launched to a more distant asteroid, much further away from Earth. While orbiting the asteroid, the spacecraft can collect data on the asteroid's shape, rotation, density, and/or surface and sub-surface composition. Through the use of multiple space craft, mission risk can be distributed across several units and allow for broad based functionality within the cluster of space craft. The space craft shown in FIG. 6 can also provide low-cost interplanetary spacecraft capability.”

Referring now to FIG. 5, additional details of the workflow elements and process steps of box 206 are illustrated. As illustrated by flow chart box 206 the explorer spacecraft 300 has also on board one or more robotic prospector spacecraft 500 that will be sent to the surface 502 of the asteroid 304 to obtain samples to be analyzed. The robotic prospector spacecraft 500 obtains the samples and can send information about the analysis electronically back to the explorer spacecraft 300 and elsewhere. The robotic prospector spacecraft 500 can also collect samples that are returned to the explorer spacecraft 300 and elsewhere.

Referring now to FIG. 6, additional details of the workflow elements and process steps of box 208 are illustrated. As illustrated by flow chart box 208, after analysis has determined areas containing desired material a mother spaceship 600 will send robotic miners 602 to the surface 502 to mine the raw materials.

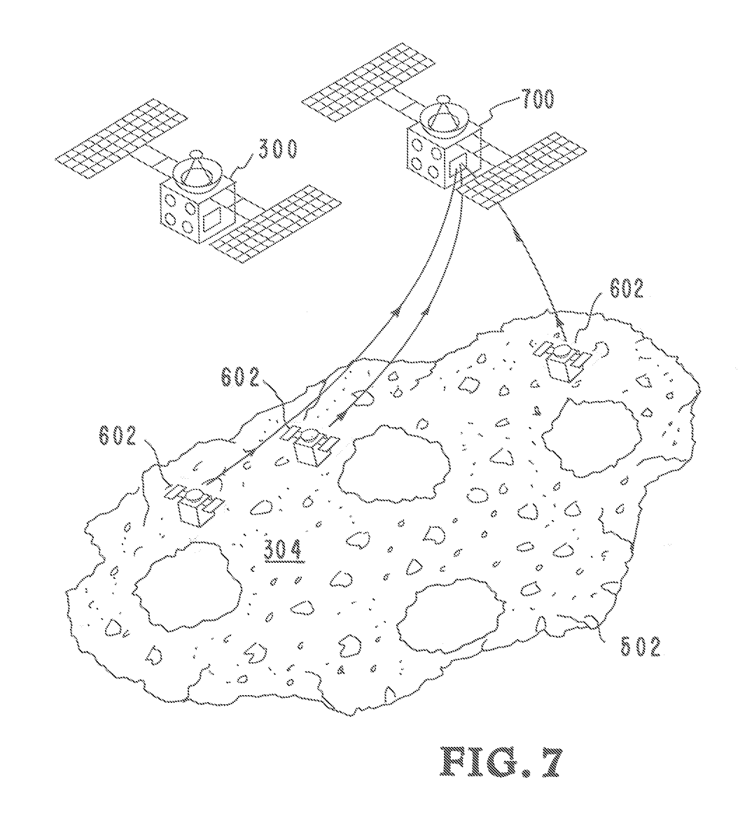

Referring now to FIG. 7, additional details of the workflow elements and process steps of box 210 are illustrated. As illustrated by flow chart box 210, the robotic miners 602 will deliver the raw materials to a nearby robotic processing ship 700 where the raw materials will be refined to a state that is suitable for use in a 3D printing process.

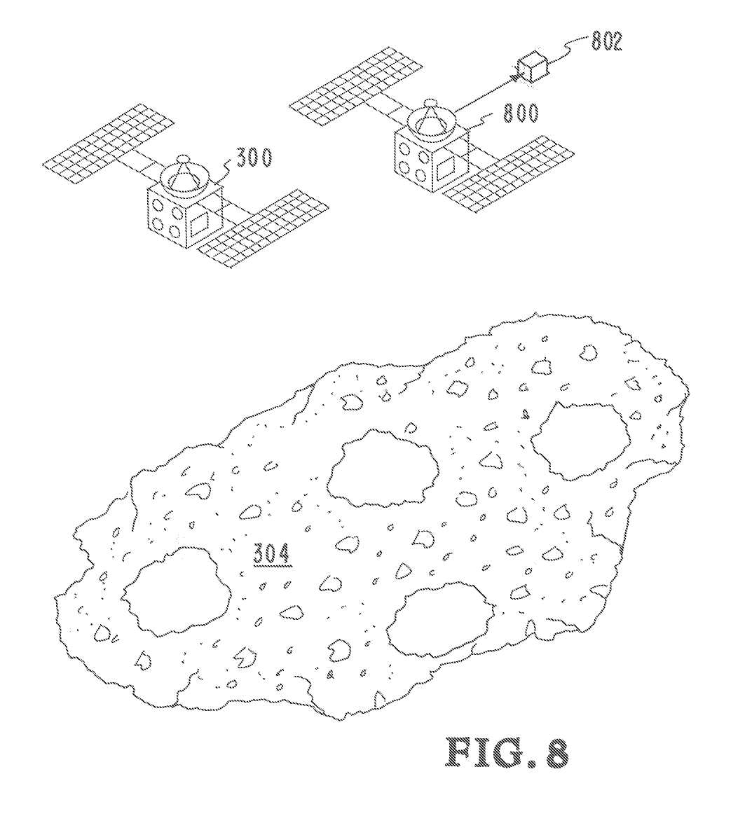

Referring now to FIG. 8, additional details of the workflow elements and process steps of box 212 are illustrated. As illustrated by flow chart box 212, the powder suitable for use in a 3D printing is used as a feed stock for additive manufacturing. A nearby robotic 3D processing ship 800 utilizes the powder in a 3D printing process to produce parts or products. The finished 3D printed parts or products 802 are then delivered to earth, a moon colony, a space station, or even a mars colony.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. An additive manufacturing method for producing parts or products, comprising the steps of:
synthesizing metal alloy powder from iron-nickel asteroids or meteorites providing synthesized metal alloy powder,
using said synthesized metal alloy powder as a feed stock for additive manufacturing, and
completing the parts or products by said additive manufacturing in space.

2. The additive manufacturing method of claim 1 wherein said additive manufacturing is selected laser melting additive manufacturing.

3. The additive manufacturing method of claim 1 wherein said additive manufacturing is laser metal deposition additive manufacturing.

4. The additive manufacturing method of claim 1 wherein said additive manufacturing is electron beam additive manufacturing.

5. An additive manufacturing method for producing parts or products in space, comprising the steps of:
locating an asteroid or meteorite,
making contact with said asteroid,
harvesting material from said asteroid or meteorite,
processing said material from said asteroid or meteorite producing additive manufacturing quality powder,
using said additive manufacturing quality powder as a feed stock for additive manufacturing in space, and
completing the parts or products by said additive manufacturing in space.

6. The additive manufacturing method for producing parts or products in space of claim 5 wherein said step of making contact with said asteroid or meteorite comprises making contact with said asteroid or meteorite using meteorites on earth to determine that said asteroid or meteorite has desired properties.

7. The additive manufacturing method for producing parts or products in space of claim 5 wherein said step of making contact with said asteroid or meteorite comprises making contact with said asteroid or meteorite using meteorites on earth to determine that said asteroid or meteorite is an iron-nickel asteroid.

8. The additive manufacturing method for producing parts or products in space of claim 5 wherein said steps of using said additive manufacturing quality powder as a feed stock for additive manufacturing in space and completing the parts or products by said additive manufacturing in space comprises the steps of using said additive manufacturing quality powder as a feed stock for selected laser melting additive manufacturing in space and completing the parts or products by said selected laser melting additive manufacturing in space

9. The additive manufacturing method for producing parts or products in space of claim 5 wherein said steps of using said additive manufacturing quality powder as a feed stock for additive manufacturing in space and completing the parts or products by said additive manufacturing in space comprises the steps of using said additive manufacturing quality powder as a feed stock for laser metal deposition additive manufacturing in space and completing the parts or products by said laser metal deposition additive manufacturing in space.

10. The additive manufacturing method for producing parts or products in space of claim 5 wherein said steps of using said additive manufacturing quality powder as a feed stock for additive manufacturing in space and completing the parts or products by said additive manufacturing in space comprises the steps of using said additive manufacturing quality powder as a feed stock for electron beam additive manufacturing in space and completing the parts or products by said electron beam additive manufacturing in space.

11. The additive manufacturing method for producing parts or products in space of claim 5 wherein said steps of using said additive manufacturing quality powder as a feed stock for additive manufacturing in space and completing the parts or products by said additive manufacturing in space comprises using said additive manufacturing quality powder as a feed stock for additive manufacturing on mars and completing the parts or products by said additive manufacturing on mars.

12. The additive manufacturing method for producing parts or products in space of claim 5 wherein said steps of using said additive manufacturing quality powder as a feed stock for additive manufacturing in space and completing the parts or products by said additive manufacturing in space comprises using said additive manufacturing quality powder as a feed stock for additive manufacturing on a space station and completing the parts or products by said additive manufacturing on a space station.

13. An additive manufacturing apparatus for producing parts or products in space, comprising the steps of:
a system for harvesting material from an asteroid or meteorite,
a system for processing said material from said asteroid or meteorite producing additive manufacturing quality powder,
a system for using said additive manufacturing quality powder as a feed stock for additive manufacturing in space, and
a system for completing the parts or products by said additive manufacturing in space.

14. The additive manufacturing apparatus for producing parts or products in space of claim 13 wherein said systems for using said additive manufacturing quality powder as a feed stock for additive manufacturing in space and completing the parts or products by said additive manufacturing in space comprises systems for using said additive manufacturing quality powder as a feed stock for selected laser melting additive manufacturing in space and completing the parts or products by said selected laser melting additive manufacturing in space

15. The additive manufacturing apparatus for producing parts or products in space of claim 13 wherein said systems for using said additive manufacturing quality powder as a feed stock for additive manufacturing in space and completing the parts or products by said additive manufacturing in space comprises systems of using said additive manufacturing quality powder as a feed stock for laser metal deposition additive manufacturing in space and completing the parts or products by said laser metal deposition additive manufacturing in space.

16. The additive manufacturing apparatus for producing parts or products in space of claim 13 wherein said systems for using said additive manufacturing quality powder as a feed stock for additive manufacturing in space and completing the parts or products by said additive manufacturing in space comprises systems for using said additive manufacturing quality powder as a feed stock for electron beam additive manufacturing in space and completing the parts or products by said electron beam additive manufacturing in space.

17. The additive manufacturing apparatus for producing parts or products in space of claim 13 wherein said systems for using said additive manufacturing quality powder as a feed stock for additive manufacturing in space and completing the parts or products by said additive manufacturing in space comprises systems for using said additive manufacturing quality powder as a feed stock for additive manufacturing on mars and completing the parts or products by said additive manufacturing on mars.

18. The additive manufacturing apparatus for producing parts or products in space of claim 13 wherein said systems for using said additive manufacturing quality powder as a feed stock for additive manufacturing in space and completing the parts or products by said additive manufacturing in space comprises systems for using said additive manufacturing quality powder as a feed stock for additive manufacturing on a space station and completing the parts or products by said additive manufacturing on a space station.

19. An additive manufacturing apparatus for producing parts or products in space, comprising the steps of:
a harvesting system for harvesting material from an asteroid or meteorite, said harvesting system including a system for controlling said harvesting system from earth when said harvesting system is in space;
a processing system for processing said material from said asteroid or meteorite producing additive manufacturing quality powder, said processing system including a system for controlling said processing system from earth when said harvesting system is in space;
an additive manufacturing system for using said additive manufacturing quality powder as a feed stock for additive manufacturing in space, said additive manufacturing system including a system for controlling said additive manufacturing system from earth when said harvesting system is in space; and
a parts completion system for completing the parts or products by said additive manufacturing in space, said parts completion system including a system for controlling said parts completion system from earth when said harvesting system is in space.

20. A method of producing parts or products by additive manufacturing in space, comprising, the steps of:
controlling a system from earth that harvests material from an asteroid or meteorite,
controlling a system from earth that processes said material from said asteroid or meteorite and produces additive manufacturing quality powder,
controlling a system from earth that uses said additive manufacturing quality powder as a feed stock for additive manufacturing in space, and
controlling a system from earth that completes the parts or products by said additive manufacturing in space.
